(19) United States
(12) Patent Application Publication
(10) Pub. No.: US 2026/0133837 A1
(43) Pub. Date: May 14, 2026

(54) DEVICE AND METHOD WITH RECONFIGURABLE ACCELERATOR

(71) Applicant: Samsung Electronics Co., Ltd., Suwon-si (KR)

(72) Inventors: Hyungwoo LEE, Suwon-si (KR); Wooseok YI, Suwon-si (KR)

(73) Assignee: Samsung Electronics Co., Ltd., Suwon-si (KR)

(21) Appl. No.: 19/256,063

(22) Filed: Jun. 30, 2025

(30) Foreign Application Priority Data
Sep. 13, 2024 (KR) 10-2024-0125928

(51) Int. Cl. G06F 9/50; G06F 9/48; G06F 15/80

(52) U.S. Cl. CPC G06F 9/5027; G06F 9/485; G06F 15/8053

(57) ABSTRACT

Provided is a processor including an accelerator including a plurality of processing elements, and an accelerator controller configured to allocate at least two processing elements from the plurality of processing elements to a vector lane, and based on a loop operation being included in an instruction set to be processed by the accelerator, release the allocation of the vector lane to suspend a vector operation of the vector lane.

### CROSS-REFERENCE TO RELATED APPLICATIONS

This application claims the benefit of Korean Patent Application No. 10-2024-0125928, filed on Sep. 13, 2024, in the Korean Intellectual Property Office, the disclosure of which is incorporated herein by reference in its entirety.

### BACKGROUND

### 1. Field

Example embodiments relate to a device and method with reconfigurable accelerator.

### 2. Description of Related Art

Processors are capable of processing various types of operations. To enhance performance and efficiency, a processor may include an accelerator for processing specific tasks, such as graphic processing, artificial intelligence computations, encryption operations, and similar workloads. These accelerators enable faster and more efficient execution of designated tasks.

Recently, reconfigurable accelerators have been developed, allowing hardware configurations to be dynamically adjusted to optimize performance for specific tasks. However, when an accelerator is not actively assigned to a task, its resources may be underutilized, leading to inefficiencies. Accordingly, there is a need for improved resource management techniques to enhance the utilization and efficiency of reconfigurable accelerators.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor includes an accelerator including a plurality of processing elements; and an accelerator controller configured to: allocate at least two processing elements from the plurality of processing elements to a vector lane, and based on a loop operation being included in an instruction set to be processed by the accelerator, release the allocation of the vector lane to suspend a vector operation on the vector lane.

The processor may further include a cache memory configured to store data related to the vector operation when the allocation of the vector lane is released.

The accelerator controller may be further configured to, upon completion of processing the instruction set, resume the suspended vector operation using the data stored in the cache memory.

The accelerator controller may be further configured to store vector configuration information for the at least two processing elements when the allocation of the vector lane is released, and upon completion of processing the instruction set, reallocate the at least two processing elements based on the stored vector configuration information to the vector lane.

The cache memory may include at least one of a level-0 cache memory and a level-1 cache memory.

The accelerator controller may be further configured to detect a presence of the loop operation in the instruction set; and identify a configuration for at least one processing element from the plurality of processing elements to process the instruction set, wherein the at least one processing element is configured to process the instruction set.

The plurality of processing elements may be arranged in rows and columns, and the allocating of at least two processing elements may include allocating the at least two processing elements from at least one selected column to the vector lane.

The processor may further include a vector pipeline including a queue configured to store at least one vector instruction; and a lane sequencer configured to control the vector lane to perform a vector operation corresponding to a vector instruction received from the queue.

The vector pipeline may further include a plurality of base vector lanes, and wherein the lane sequencer is configured to control at least one of the plurality of base vector lanes to perform the vector operation corresponding to the vector instruction received from the queue.

In one general aspect, a method of operating a processor including a plurality of processing elements includes allocating at least two processing elements from the plurality of processing elements to a vector lane; and upon detecting that an instruction set to be processed includes a loop operation, stopping a vector operation of the vector lane.

The method may further include performing the vector operation of the vector lane; and determining whether the instruction set includes the loop operation.

The method may further include when the vector operation of the vector lane is stopped, storing data related to the vector operation.

The method may further include upon completion of processing the instruction set, resuming the vector operation of the vector lane using the stored data related to the vector operation.

The method may further include when the vector operation of the vector lane is stopped, storing vector configuration information for the at least two processing elements; and upon completion of processing the instruction set, reallocating the at least two processing elements to the vector lane based on the stored vector configuration information.

The storing data related to the vector operation may include storing the data in at least one of a level-0 cache memory and a level-1 cache memory.

The method may further include when detecting that the instruction set includes the loop operation, determining a configuration of at least one processing element to process the instruction set; and processing the instruction set using the at least one processing element corresponding to the configuration.

The plurality of processing elements may be arranged in rows and columns, and wherein the allocating of at least two processing elements to the vector lane includes selecting the at least two processing elements from at least one column among the columns to the vector lane.

The method may further include performing a vector operation using at least one of a plurality of base vector lanes of a vector pipeline included in the processor.

The method may further include storing a vector instruction corresponding to the vector operation in a queue of the vector pipeline.

In one general aspect, an electronic device includes an accelerator including a plurality of processing elements; a main processor configured to output an instruction set to be processed by the accelerator; and an accelerator controller configured to: in a default mode, allocate at least two processing elements from the plurality of processing elements to a vector lane for performing vector operations, determine whether the instruction set received from the main processor includes a loop operation, and release the allocated processing elements from the vector lane, which suspends the vector operation, based on the loop operation being included in the instruction set.

Other features and aspects will be apparent from the following detailed description, the drawings, and the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a processor according to one or more embodiments;

FIG. 2 illustrates an accelerator according to one or more embodiments;

FIG. 3 illustrates in detail the processor of FIG. 1 according to one or more embodiments;

FIG. 4 illustrates a processor according to one or more embodiments;

FIG. 5 illustrates in detail the processor of FIG. 4 according to one or more embodiments;

FIG. 6 is a flowchart illustrating a method of operating a processor according to one or more embodiments; and

FIG. 7 illustrates a method of operating a processor according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

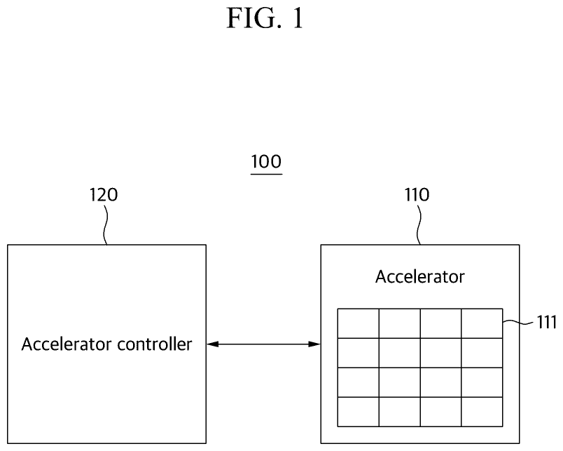

FIG. 1 illustrates a processor according to one or more embodiments.

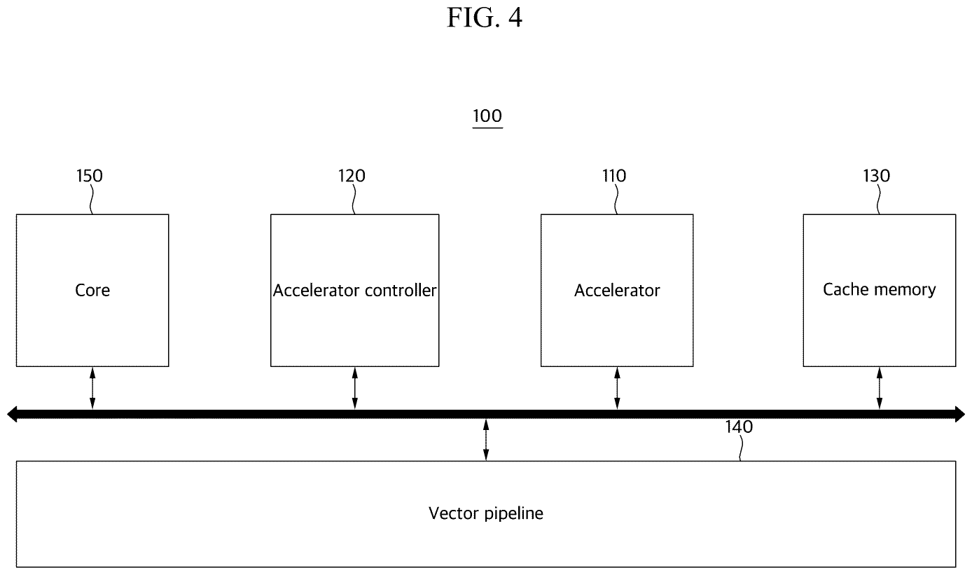

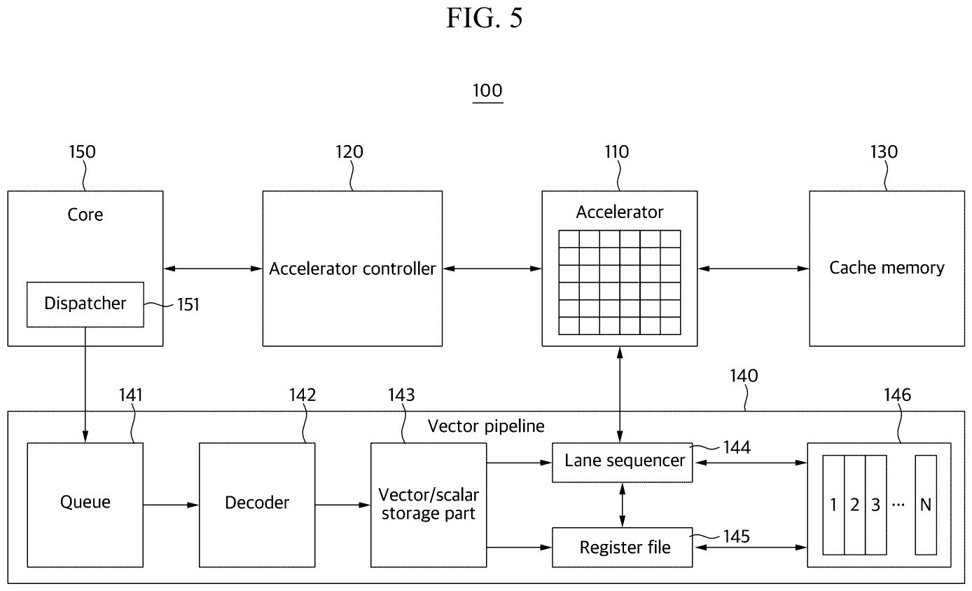

Referring to FIG. 1, a processor 100 may be configured to perform various tasks, including processing operations. In one embodiment, the processor 100 may be included in one of various electronic devices. For example, the processor 100 may be included in a computer, a data center, a server, or a supercomputer. However, these examples are not limiting, and the processor 100 may also be included in other electronic devices, such as a smartphone, a tablet, a wearable device, home appliances, an automobile, a drone, a robot, or an Internet of Things (IoT) device. In one embodiment, the processor 100 may be an electronic device, which may include an accelerator 110 and an accelerator controller 120, as shown in FIG. 1. Additionally, the electronic device may further include at least one of the components described in FIGS. 4 and 5, which is explained below.

The processor 100 may include an accelerator 110 and an accelerator controller 120. In some embodiments, the accelerator 110 and the accelerator controller 120 may be fabricated as a single integrated chipset. In other embodiments, the accelerator 110 and the accelerator controller 120 may be fabricated as separate chipsets.

The accelerator 110 may include a plurality of processing elements (PEs) 111. Each the processing element 111 may perform (or process) an individual operation, allowing multiple operations to be executed in parallel. In some embodiments, each processing element 111 may include an arithmetic logic unit (ALU) configured to perform various arithmetic operations (e.g., addition, subtraction, multiplication, and division) and logical operations (e.g., AND, OR, NOT, and XOR). Moreover, each processing element 111 may include a floating point unit (FPU) configured to perform floating-point operations. In some embodiments, each processing element 111 may further include a register file for storing data required for operations.

The accelerator controller 120 may control the operation of the accelerator 110.

In some embodiments, the accelerator controller 120 may determine a configuration of the processing element 111 based on an operation to be executed/processed on the accelerator 110. The accelerator controller 120 may dynamically modify input and output connection states of the processing elements 111 based on the configuration. The processing order and connection states of the processing elements 111 may be adjusted dynamically change based on an operation to be processed. For example, the accelerator controller 120 may connect an output of a first processing element to an input of a second processing element, allowing the result of a first operation executed by the first processing element to serve as input data for a second operation executed by the second processing element. The connection state of the processing elements 111 may be configured in a serial connection, a parallel connection, or a combination thereof. The term ‘connection state’ may refer not only to configurations wherein all processing elements are interconnected, but also to configurations wherein only a subset of the processing elements is interconnected, with the remaining elements being disconnected. In a serial connection, the output of one processing element is directly transmitted as the input to the next processing element. In a parallel connection, multiple processing elements may receive the same input and perform operations independently. The accelerator controller 120 may dynamically determine these connection states based on the characteristics of the operation and the properties of the data.

In some embodiments, the accelerator controller 120 may allocate at least two processing elements 111 to a vector lane. The vector lane may be a unit grouping of two or more processing elements 111 that perform vector operations. A vector operation may include parallel execution of operations on each vector element within a vector dataset. For example, when N processing elements 111 are allocated to a single vector lane, the vector lane may process operations on N vector elements in parallel, where N is a natural number greater than or equal to 2.

The accelerator controller 120 may identify whether a loop operation is included in an instruction set to be executed by the accelerator 110. In some embodiments, the phrase ‘the instruction set includes the loop operation’ may mean that the instruction set includes one or more instructions associated with (an execution of) the loop operation. In some embodiments, the instructions associated with the loop operation may include an instruction that executes one operation within the loop operation. In some embodiments, the instruction associated with the loop operation may include a predefined instruction that controls the execution of the loop operation. In some embodiments, the instruction associated with the loop operation may itself be the loop operation. The accelerator controller 120 may stop (or suspend) the vector operation of the vector lane when the loop operation is included in the instruction set to be executed on the accelerator 110. For example, the accelerator controller 120 may periodically analyze received instructions or assess each received instruction to determine whether a received instruction includes the loop operation. In some embodiments, the instruction set may be received from the outside of the accelerator controller 120. For example, the instruction set may be received from a core external to the accelerator controller 120. The instruction may be any of a variety of instructions, possibly loop-explicit, in the instruction set, for example, a scalar Single-Precision A·X Plus Y (SAXPY) operation, arithmetic operation within a loop, or logical operation within a loop. Any method of loop detection may be used. For example, the loop operation may be detected by examining structure and parameters of the instruction: for arithmetic operations, by identifying recurring calculation patterns or explicit iteration counts, and for logical operations, by detecting conditional branch instructions or control signals indicative of iterative execution.

Upon detecting a loop operation, the accelerator controller 120 may suspend the vector operation and determine an optimal configuration for the processing element 111 based on the instruction set to be processed on the accelerator 110. The accelerator controller 120 may dynamically modify an input and output connection state of the processing element 111 according to the configuration and control the processing element 111 to process the instruction set.

According to example embodiments of the present disclosure, the processor 100 provides improved resource efficiency and an enhanced operation method. Hereinafter, some embodiments are described in more detail with reference to the accompanying drawings.

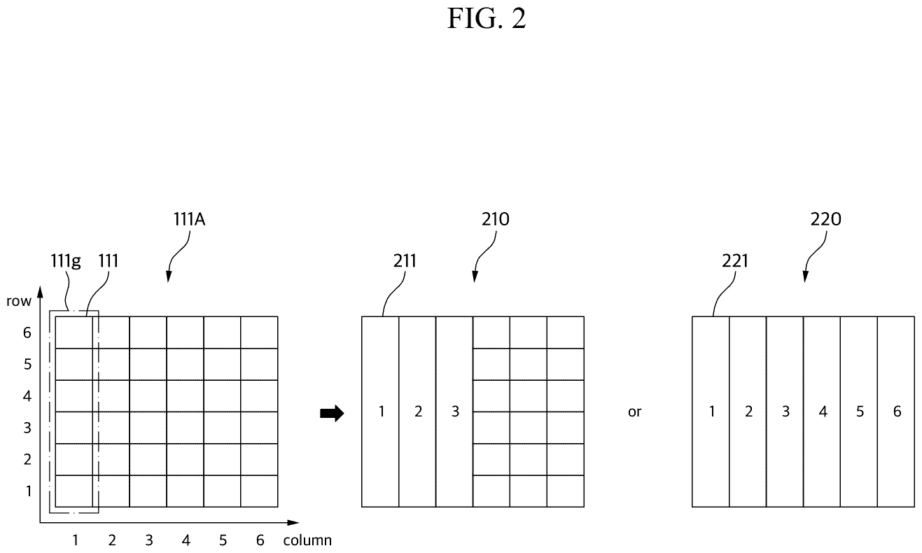

FIG. 2 illustrates an accelerator according to one or more embodiments.

Referring to FIGS. 1 and 2, in some embodiments, the accelerator 110 may include a processing element array 111A. The processing element array 111A may include the plurality of processing elements 111, which may be arranged in rows and columns, forming an array structure/topology. Each processing element 111 may be assigned a unique address, which may include a row address and a column address. The number of rows and the number of columns illustrated in FIG. 2 is provided as an example and may vary depending on implementation requirements.

In some embodiments, until the loop operation is identified, the accelerator controller 120 may allocate at least two processing elements 111 to a single vector lane. In other words, during a default mode, the accelerator controller 120 may configure at least two processing elements 111 as one vector lane to perform vector operations.

In some embodiments, the accelerator controller 120 may allocate at least two processing elements arranged in at least one of the plurality of columns to respective vector lanes. The number of processing elements assigned to a vector lane may dynamically vary based on complexity of the vector operation. Additionally, the accelerator controller 120 may reconfigure the vector lanes during operation to adapt to changing workloads and optimize resource utilization. For example, the accelerator controller 120 may allocate a plurality of processing elements 111g arranged in a same column to one vector lane 211 or 221. In some cases, all processing elements within one column may be allocated to one vector lane 211 or 221, whereas in other cases, only some processing elements (a subset of processing elements) within one column may be allocated to a particular vector lane (e.g., one vector lane 211 or 221).

In some embodiments, the accelerator controller 120 may allocate a vector lane for some of the plurality of columns (a subset of the columns). For example, as illustrated in a first example 210, the vector lane 211 may be allocated for some columns within the array. Processing elements within the vector lane 211 may perform a vector operation, and the connection states of the processing elements may be dynamically adjusted to optimize the performance of the vector operation. For example, the processing elements allocated to the vector lane 211 may be connected in a parallel configuration, a serial configuration, or a combination thereof. Meanwhile, columns that are not assigned to a vector lane may be used for operations other than vector processing.

In some embodiments, the accelerator controller 120 may allocate a vector lane for all columns within the array. For example, as illustrated in a second example 220, the vector lane 221 may be allocated for all available columns.

While the above embodiments describe the vector lanes 211 and 221 being allocated on a column basis, in some embodiments, vector lanes may instead be allocated on a row basis.

In some embodiments, upon detecting the loop operation within the instruction set, the accelerator controller 120 may suspend the vector operation by deallocating the vector lane 211 or 221. In other words, the accelerator controller 120 may release the connection state of the processing elements 111 allocated to the vector lane 211 or 221 or may change the connection state into a previous state (i.e., restore the processing elements 111 to a previous configuration).

In such cases, the accelerator controller 120 may determine a new configuration of the processing elements 111 based on the instruction set. Specifically, the accelerator controller 120 may reconfigure the processing elements 111 to accommodate the loop operation. The connection states of the processing elements 111 may be adjusted accordingly, allowing them to process the instruction set (or the loop operation) efficiently.

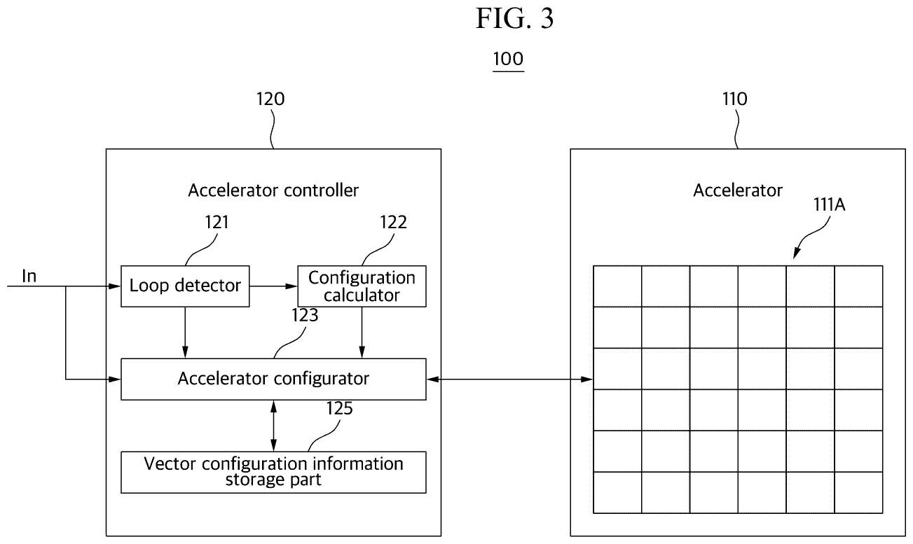

FIG. 3 illustrates in detail a processor according to one or more embodiments.

Referring to FIGS. 2 and 3, in some embodiments, the accelerator controller 120 may include a loop detector 121, a configuration calculator 122, an accelerator configurator 123, and a vector configuration information storage part 125. These components may be interconnected via a bus. The accelerator 110 may include the processing element array 111A including the plurality of processing elements 111.

The loop detector 121 may identify and analyze an instruction set In, which may be received from a core, to determine whether a loop operation is included in or associated with the instruction set In. For example, during the default mode, various methods may be employed to identify a loop operation. These methods may include the following non-limiting examples of detecting: whether a command, a statement or syntax included in the instruction set In indicates a loop operation, such as ‘for’ or ‘while’; whether an operation included in in the instruction set In is repeated more than a predetermined number of times (e.g., three times, four times, etc.); whether a specific instruction location in the instruction set In is repeatedly accessed; whether a conditional branch instruction included in the instruction set In is used to return from an end of a loop to a beginning of the loop based on a condition; whether a specific variable (e.g., index value) changes consistently or repeats; and whether specific variables, such as loop counters or indices, increase or decrease in a consistent pattern.

When it is determined that the loop operation is included in the instruction set In, the loop detector 121 may transmit a detection signal indicating that the loop operation is included in the instruction set In and/or the Instruction set In to the configuration calculator 122. Additionally, the loop detector 121 may transmit the detection signal to the accelerator configurator 123.

Upon receiving an indication that a loop operation is included in the instruction set In, the configuration calculator 122 may determine an optimal configuration for processing elements to execute the instruction set In. The configuration calculator 122 may then transfer the determined configuration to the accelerator configurator 123.

Until it is detected/identified that the loop operation is included in the instruction set In, the accelerator configurator 123 may allocate at least two processing elements 111 from the processing element array 111A to one vector lane. The accelerator configurator 123 may adjust/change a connection state of the at least two processing elements allocated to the vector lane to support vector operations. The vector lane may then perform the vector operations either under the control of the accelerator configurator 123 or under the control of a separate vector pipeline. For example, the vector operations may include, but are not limited to, multiply-accumulate operations, convolution operations, vector dot product operations, and vector sum operations.

The vector configuration information storage part 125 may store vector configuration information/data, which may include processing element addresses, vector lane addresses, and corresponding relationships thereof. The accelerator configurator 123 may utilize the vector configuration information to allocate a specific processing element to a corresponding specific vector lane. In some embodiments, the vector configuration information may further include connection states of the processing elements 111, sizes of data to be processed in the vector operation, and/or operation units (e.g., 32 bits and 64 bits).

When it is detected/identified that the loop operation is included in the instruction set In, the accelerator configurator 123 may deallocate the vector lane and suspend/stop the associated vector operation of the vector lane. For example, the accelerator configurator 123 may, upon receiving the detection signal from the loop detector 121, release the vector lane allocation.

The accelerator configurator 123 may then configure a processing element among the plurality of processing elements 111 to execute the instruction set based on the determined configuration. For example, the accelerator configurator 123 may select a processing element based on the determined configuration and modify a connection state of the selected processing element to align with the required execution structure.

In some embodiments, upon deallocating a vector lane, the accelerator configurator 123 may store the vector configuration information of the previously allocated processing elements in the vector configuration information storage unit 125. After completing the processing of the instruction set, the accelerator configurator 123 may reallocate the processing elements to the vector lane based on the stored vector configuration information, allowing resumption of the halted vector operation.

The loop operation included in the instruction set In may include a scalar SAXPY operation, represented by the following Equation 1.

$$z [ i ] = a \times x [ i ] + y [ i ] , for i = 1 : n \qquad Equation 1$$

Here, a is a constant scalar value. i is a loop index ranging from 1 to n, where n is a natural number greater than or equal to 2. The values x[i] and y[i] are scalar input data, while z[i] is scalar output data (or result data).

For example, the configuration calculator 122 may identify that a first unit operation of (a×x[i]) and a second unit operation of (+y[i]) are included in each loop in a loop operation of Equation 1. The configuration calculator 122 may determine a configuration where an output of a processing element performing the first unit operation is connected to an input of a processing element performing the second unit operation. The accelerator configurator 123 may then select a processing element based on the configuration and change a connection state of the selected processing element.

Further, the accelerator configurator 123 may select a group of processing elements to perform the first unit operation and the second unit operation among the plurality of processing elements 111. For example, the accelerator configurator 123 may select a first processing element to perform the first unit operation of (a×x[i]) and a second processing element to perform the second unit operation of (+y[i]) among the plurality of processing elements 111. In this case, the first and second processing elements may be selected from an idle state and positioned adjacent to each other. The accelerator configurator 123 may modify/change their connection state(s) so that an output of the first processing element is connected to an input of the second processing element. Additionally, the accelerator configurator 123 may select multiple groups of processing elements to perform the first and second unit operations in parallel, depending on the number of iterations in the loop. This parallel execution can enhance processing efficiency and optimize computational throughput.

FIG. 4 illustrates a processor according to one or more embodiments.

Referring to FIGS. 3 and 4, the processor 100 may include the accelerator 110 and the accelerator controller 120. The processor 100 may further include at least one of a cache memory 130, a vector pipeline 140, and a core 150. For example, the accelerator 110, the accelerator controller 120, the cache memory 130, the vector pipeline 140, and the core 150 may be interconnected via a bus.

In some embodiments, the accelerator 110, the accelerator controller 120, the cache memory 130, the vector pipeline 140, and the core 150 may be fabricated as one integrated chipset. In other embodiments, one or more of these components may be fabricated as separate chipsets. Although the cache memory 130 is illustrated as being located outside the core 150, this arrangement is only an example and may be modified so that the cache memory 130 is located within the core 150. Hereinafter, a duplicated description of the accelerator 110 and the accelerator controller 120 is omitted.

In some embodiments, when a loop operation is detected in an instruction set, the accelerator configurator 123 may stop the vector operation by deallocating the corresponding vector lane.

When the vector lane is deallocated (or the vector operation is stopped), the cache memory 130 may store data related to the vector operation of the corresponding vector lane. For example, such data related to the vector operation may include intermediate data generated during the vector operation. The intermediate data may include at least one of a progress state of the vector operation, intermediate result values, and a current configuration information of the vector lane. In some embodiments, once processing of the instruction set is completed, the accelerator configurator 123 may resume the stopped vector operation of the vector lane using the intermediate data stored in the cache memory 130. Alternatively, the vector operation data may be stored in a register file of the vector pipeline 140.

In some embodiments, the cache memory 130 may include at least one of a level-0 (L0) cache memory and a level-1 (L1) cache memory. The L0 cache memory may offer faster speed than but lower capacity compared to the L1 cache memory. In some embodiments, the L0 and L1 cache memories may be located inside or outside the core 150. Moreover, the cache memory 130 may be configured to include additional levels, such as a level 2 (L2) cache memory.

The vector pipeline 140 may be a dedicated hardware device for performing vector operations. For example, the vector pipeline 140 may serve as a co-processor for the core 150. The vector pipeline 140 may directly perform the vector operations or, when a plurality of processing elements included in the accelerator 110 are allocated to a vector lane, may control the vector lane to perform the vector operation.

The core 150 may be a hardware device for performing a general-purpose operation. For example, the core 150 may be a main processor (or a main processing unit). The core 150 may process program instructions and perform operations. The processor 100 may include one or more cores. In some embodiments, the core 150 may include a control device, an operation device, and a register. The core 150 may generate and dispatch/output the instructions to the accelerator 110, and such instructions may include commands for vector operations or loop operations. The accelerator 110 may then process these instructions to perform tasks such as parallel computation or data processing.

FIG. 5 illustrates in detail a processor according to one or more embodiments.

Referring to FIGS. 4 and 5, the processor 100 may include the accelerator 110 and the accelerator controller 120. The processor 100 may further include at least one of the cache memory 130, the vector pipeline 140, and the core 150.

In some embodiments, the core 150 may include a dispatcher 151, which may be configured to distribute instructions included in the instruction set based on the type of the instructions. For example, the dispatcher 151 may allocate an instruction to a component best suited to process the instruction based on the type of the instruction. The dispatcher 151 may determine the timing of instruction distribution based on factors such as the instruction type, instruction priority, and an idle state of the components (e.g., the accelerator controller 120, the vector pipeline 140, etc.).

In some embodiments, the dispatcher 151 may distribute and transfer instructions to the accelerator controller 120 or the vector pipeline 140. For example, the dispatcher 151 may transfer an instruction set including a vector operation to the vector pipeline 140, and transfer an instruction set including a loop operation to the accelerator controller 120. Here, the instruction set including the vector operation is referred to as a vector instruction.

In some embodiments, the vector pipeline 140 may include at least one of the following components: a queue 141, a decoder 142, a vector/scalar storage part 143, a lane sequencer 144, a register file 145, and a plurality of base vector lanes 146. In some cases, the plurality of base vector lanes 146 may be omitted.

The queue 141 may store one or more vector instructions received from the core 150. The queue 141 may store the vector instructions in an order received, and the vector instructions stored in the queue 141 may be outputted sequentially in that same order.

The decoder 142 may interpret the vector instruction outputted from the queue 141. In some embodiments, the decoder 142 may convert the vector instruction into a signal that may be processed on the vector lane or the base vector lane 146. For example, the decoder 142 may convert the vector instruction into a control signal specifying the vector operation.

The vector/scalar storage part 143 may store data used in vector operations. In some embodiments, the vector/scalar storage part 143 may store vector data, scalar data, and even result data generated during the vector operation. The vector/scalar storage part 143 may provide the stored data to the executing hardware to perform the vector operation.

The lane sequencer 144 may control the vector lane or the base vector lane 146 to perform a vector operation corresponding to the vector instruction output from the queue 141. For example, the lane sequencer 144 may determine whether the vector operation is processed on the base vector lane 146 or on the vector lane. In some embodiments, the lane sequencer 144 may determine whether the vector operation is processed on the vector lane when the base vector lane 146 of an idle state is not present. In other words, the base vector lane 146 is given higher priority for executing vector operations than the vector lane. However, this priority scheme is exemplary and may be modified in alternative implementations.

The register file 145 may be a high-speed memory region that may temporarily store data required during vector operations executed on the vector lane or the base vector lane 146. In some embodiments, the register file 145 may store/hold intermediate data or final result data of the vector operations.

The base vector lane 146 is a hardware device designed to perform vector operations. In some embodiments, while one processing element 111 may perform a single operation, one base vector lane 146 may comprise multiple processing elements, enabling it to perform a plurality of single operations. At least one base vector lane 146 may be used to process a given vector operation, and multiple base vector lanes may operate in parallel to enhance throughput.

In some embodiments, the processing element 111 of the accelerator 110 may be operated as an additional vector lane alongside the base vector lane 146. By minimizing idle time within the accelerator 110, overall resource utilization is improved, thereby enhancing processor 100's computational power and operational performance. Furthermore, for a given performance level, processor 100 may be reduced in size. For example, even though the accelerator 110 is generally having larger than the core 150, its capability to engage in operations (such as vector operations) even when not used for acceleration can lead to enhanced overall performance and more effective resource utilization.

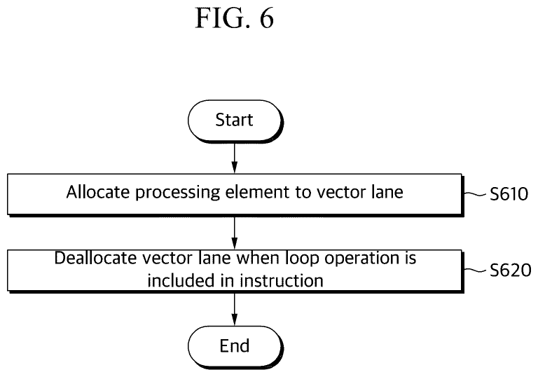

FIG. 6 is a flowchart illustrating an operation method of a processor according to one or more embodiments.

Referring to FIG. 6, the operation method of the processor 100 may include allocating at least two processing elements from a plurality of processing elements to form a vector lane (operation S610), and when a loop operation is included in an instruction set to be processed, stopping the vector operation of the vector lane (operation S620). The processor 100 may include the plurality of processing elements 111. In example embodiments, the processor 100 may include the plurality of processing elements 111, which, in some embodiments, are provided within accelerator 110.

In this method, at least two processing elements from the plurality of processing elements are allocated to the vector lane (operation S610).

In some embodiments, the plurality of processing elements 111 may be arranged in an array comprising multiple rows and columns. The connection states of the plurality of processing elements 111 may be dynamically reconfigured. In such embodiments, each processing element 111 may perform a single operation, while the vector lane, as a collective unit, performs a vector operation. The processing elements allocated to the vector lane may be interconnected in either a parallel or serial configuration.

Allocation to the vector lane (operation S610) may include, for at least one column in the array, allocating at least two processing elements in that column to a corresponding vector lane. For example, the vector lane may be allocated across all of the plurality of columns or only a subset of the plurality of columns.

The operation method may further include storing a vector instruction corresponding to the vector operation in the queue 141 of the vector pipeline 140 included in the processor 100. In some embodiments, the vector lane may perform the vector operation based on the vector instruction output from the queue 141. Alternatively, the operation method may include performing the vector operation by one or more of the plurality of base vector lanes 146 of the vector pipeline 140 included in the processor 100.

The vector operation of the vector lane may be stopped when a loop operation is included in an instruction set to be processed (operation S620). The loop operation may be characterized by a structure in which a specific instruction (or task) is repeated in each iteration of a loop. In some embodiments, the loop operation may be a target for acceleration through parallel processing by the accelerator 110.

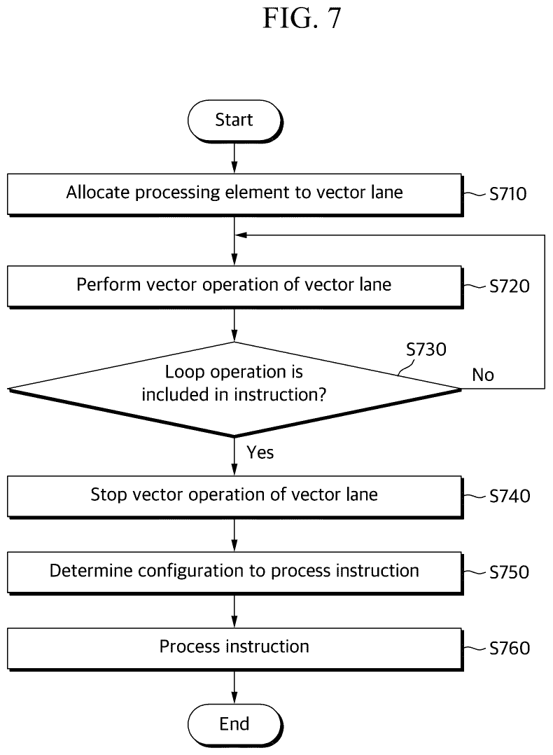

FIG. 7 is a diagram illustrating an alternative operation method of a processor according to one or more embodiments.

Referring to FIG. 7, the operation method of the processor 100 may include allocating at least two processing elements to a vector lane (operation S710) and performing a vector operation using the vector lane (operation S720).

The operation method of the processor 100 may also include identifying whether a loop operation is included in an instruction set (operation S730).

Based on the outcome of operation S730, if the loop operation is detected (i.e., the loop operation is included in the instruction set) (operation S730, Yes), the vector operation is halted (operation S740); if no loop operation is detected (operation S730, No), the vector operation continues (operation S720). In these embodiments, the processing elements 111 allocated to the vector lane remain operated until the loop operation is identified.

When the vector operation is stopped, the method may include storing data (e.g., intermediate data of the vector operation) related to the vector operation. Here, the intermediate data of the vector operation may be stored in cache memory within the processor 100. In some embodiments, the intermediate data of the vector operation may be stored in at least one of a level-0 cache memory and a level-1 cache memory; alternatively, the intermediate data of the vector operation may be stored in the register file 145 of the vector pipeline 140 included in the processor 100.

In some embodiments where the loop operation is detected (operation S730, Yes), the method may further include determining a configuration for a processing element to process the instruction set (operation S750) and executing the instruction set using the processing element corresponding to that configuration (operation S760).

The method may also include, when the vector operation is stopped, storing vector configuration information for at least two processing elements.

Subsequently, upon completion of the instruction set processing, the method may include reallocating at least two processing elements to the vector lane based on the stored vector configuration information. In other words, the processing elements deallocated from the vector lane may be reassigned/reallocated to the vector lane upon completion of the instruction set.

Finally, once the instruction set processing is completed, the method may include resuming the vector operation of the vector lane using the previously stored intermediate data. The electronic apparatus according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor. The example embodiments may be represented by functional block elements and various processing steps. The functional blocks may be implemented in any number of hardware and/or software configurations that perform specific functions. For example, an example embodiment may adopt integrated circuit configurations, such as memory, processing, logic, and/or look-up table, that may execute various functions by the control of one or more microprocessors or other control devices. Similarly to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing.

The devices, the processors, the memories, the accelerators, the controllers, the cores, the detectors, the calculators, and other components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor comprising:
an accelerator including a plurality of processing elements; and
an accelerator controller configured to:
allocate at least two processing elements from the plurality of processing elements to a vector lane, and
based on a loop operation being included in an instruction set to be processed by the accelerator, release the allocation of the vector lane to suspend a vector operation of the vector lane.

2. The processor of claim 1, further comprising:
a cache memory configured to store data related to the vector operation when the allocation of the vector lane is released.

3. The processor of claim 2, wherein the accelerator controller is further configured to:
upon completion of processing the instruction set, resume the suspended vector operation using the data stored in the cache memory.

4. The processor of claim 3, wherein the accelerator controller is further configured to:
store vector configuration information for the at least two processing elements when the allocation of the vector lane is released, and
upon completion of processing the instruction set, reallocate the at least two processing elements based on the stored vector configuration information to the vector lane.

5. The processor of claim 2, wherein the cache memory includes at least one of a level-0 cache memory and a level-1 cache memory.

6. The processor of claim 1, wherein the accelerator controller is further configured to:
detect a presence of the loop operation in the instruction set; and
identify a configuration for at least one processing element from the plurality of processing elements to process the instruction set,
wherein the at least one processing element is configured to process the instruction set.

7. The processor of claim 1, wherein the plurality of processing elements are arranged in rows and columns, and
wherein the allocating of at least two processing elements includes allocating the at least two processing elements from at least one selected column to the vector lane.

8. The processor of claim 1, further comprising:
a vector pipeline including a queue configured to store at least one vector instruction; and
a lane sequencer configured to control the vector lane to perform a vector operation corresponding to a vector instruction received from the queue.

9. The processor of claim 8, wherein the vector pipeline further includes a plurality of base vector lanes, and
wherein the lane sequencer is configured to control at least one of the plurality of base vector lanes to perform the vector operation corresponding to the vector instruction received from the queue.

10. A method of operating a processor including a plurality of processing elements, the method comprising:
allocating at least two processing elements from the plurality of processing elements to a vector lane; and
based on a loop operation being included in an instruction set to be processed, stopping a vector operation of the vector lane.

11. The method of claim 10, further comprising:
performing the vector operation of the vector lane; and
determining whether the instruction set includes the loop operation.

12. The method of claim 10, further comprising:
when the vector operation of the vector lane is stopped, storing data related to the vector operation.

13. The method of claim 12, further comprising:
upon completion of processing the instruction set, resuming the vector operation of the vector lane using the stored data related to the vector operation.

14. The method of claim 13, further comprising:
when the vector operation of the vector lane is stopped, storing vector configuration information for the at least two processing elements; and
upon completion of processing the instruction set, reallocating the at least two processing elements to the vector lane based on the stored vector configuration information.

15. The method of claim 12, wherein the storing data related to the vector operation comprises storing the data in at least one of a level-0 cache memory and a level-1 cache memory.

16. The method of claim 10, further comprising:
when detecting that the instruction set includes the loop operation, determining a configuration of at least one processing element to process the instruction set; and
processing the instruction set using the at least one processing element corresponding to the configuration.

17. The method of claim 10, wherein the plurality of processing elements are arranged in rows and columns, and
wherein the allocating of at least two processing elements to the vector lane comprises selecting the at least two processing elements from at least one column among the columns to the vector lane.

18. The method of claim 10, further comprising:
performing a vector operation using at least one of a plurality of base vector lanes of a vector pipeline included in the processor.

19. The method of claim 18, further comprising:
storing a vector instruction corresponding to the vector operation in a queue of the vector pipeline.

20. An electronic device comprising:
an accelerator including a plurality of processing elements;
a main processor configured to output an instruction set to be processed by the accelerator; and
an accelerator controller configured to:
in a default mode, allocate at least two processing elements from the plurality of processing elements to a vector lane for performing a vector operation,
determine whether the instruction set received from the main processor includes a loop operation, and
release the allocated processing elements from the vector lane, which suspends the vector operation, based on the loop operation being included in the instruction set.
